(19) United States
(12) Patent Application Publication
(10) Pub. No.: US 2012/0109703 A1
(43) Pub. Date: May 3, 2012

(54) DISTRIBUTED COMPUTING TO REDUCE A LATENCY OF DATA ANALYSIS OF A SALES AND OPERATIONS PLAN

(75) Inventors: CHANDRA P. AGRAWAL, Pleasanton, CA (US); Glen William Margolis, San Ramon, CA (US)

(73) Assignee: Steelwedge Software, Inc., Pleasanton, CA (US)

(21) Appl. No.: 12/912,784

(22) Filed: Oct. 27, 2010

(51) Int. Cl. G06Q 10/00

(52) U.S. Cl. 705/7.22; 705/7.25; 705/7.11

(57) ABSTRACT

In one embodiment, a method includes creating a demand plan in a distributed cloud infrastructure based on a demand-forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. In addition, the method includes creating a supply plan in the distributed cloud infrastructure based on another supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder. In addition, the method includes applying a planning algorithm using a combined processing power of available ones of the set of processing units in the distributed cloud infrastructure to create a build plan.

### FIELD OF TECHNOLOGY

This disclosure relates generally to a field of data analysis of a sales and operations plan. More particularly, the disclosure relates to a method, system and an apparatus of reducing latency of the data analysis of the sales and operations plan associated with an enterprise.

### BACKGROUND

Data analysis may be a process of inspecting, cleaning, transforming, and modeling data with a goal of highlighting useful information, suggesting conclusions, and supporting decision making. Data analysis may be applied to sales and operations planning to assist corporate executives, business unit heads and planning managers to evaluate plans and activities based on economic impact and/or other considerations.

Data for a sales and operations plan may be collected from employees in different divisions and/or departments within the enterprise. The amount of data required for effective business planning for the enterprise may be large. Processing the data may be computationally intensive and very expensive. The enterprise may need to invest in additional infrastructure to process the data of the sales and operations plan. Additionally, processing the data may be time intensive. For example, a user may request a report of the sales and operations plan, and by the time the report is prepared, the report may be outdated. As a result, enterprises may not be able to operate effectively and/or efficiently with reports of sales and operations plans that are too expensive and/or time intensive to create.

### SUMMARY

Embodiments of the disclosure relate to a method, a system and an apparatus of distributed computing to reduce a latency of data analysis of a sales and operations plan. In one aspect, a method includes creating a demand plan in a distributed cloud infrastructure based on a demand-forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. In addition, the method includes creating a supply plan in the distributed cloud infrastructure based on a supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder. The method also includes determining that a set of processing units in the distributed cloud infrastructure is available to process the demand plan and the supply plan. In addition, the method includes applying a planning algorithm using a combined processing power of available ones of the set of processing units in the distributed cloud infrastructure to create a build plan when the at least one of the demand plan and the supply plan is processed in the distributed cloud infrastructure. The method further includes reverting to a dedicated server processing to create the build plan when the set of processing units in the distributed cloud infrastructure is unavailable.

In another aspect, a method of a client device includes determining a set of a data of a sales and operations plan such that a report of the sales and operations plan is generated based on an analysis of the data. In addition, the method includes processing the set of the data of the sales and operations plan such that the data is processed through a distributed network of a cloud environment. The method also includes reducing a latency of a generation of the report of the sales and operations plan through a parallel processing of the set of the data of the sales and operations plan through the distributed network of the cloud environment. In addition, the method includes processing a part of the sales and operations plan based on the set of the data of the sales and operations plan prior to a request through a client device such that the latency is reduced when a calculation of the part of the sales and operations plan is requested through the client device.

In yet another aspect, a system includes a client device to determine a set of a data of a sales and operations plan such that a report of the sales and operations plan is generated based on an analysis of the data. In addition, the system includes a server device to analyze the set of the data of the sales and operations plan based on an interdependency of the data. The system also includes an agent to register the client device to the server device such that the server device pushes a calculation of the sales and operations plan to the client device.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic representation of a block diagram of a planning environment, according to one or more embodiments.

FIG. 2 is a schematic representation of a latency module of a server of the environment, according to one or more embodiments.

FIG. 3 is a schematic representation of a set of data of sales and operations plan, according to one or more embodiments.

FIG. 4 is a schematic representation of a first table and a second table of contents of parallel processing of sales and operations plan, according to one or more embodiments.

FIG. 5 is a flowchart for generating a response based on analyzing an input data, according to one or more embodiments.

FIG. 6 is a schematic representation of a system generating a response based on analyzing an input data, according to one or more embodiments.

FIG. 7 is a schematic representation of a system illustrating an available computing environment, according to one or more embodiments.

Other features of the present embodiments will be apparent from the accompanying drawings and from the detailed description that follows.

### DETAILED DESCRIPTION

A method, system and apparatus of distributed computing to reduce a latency of data analysis of a sales and operations plan is disclosed. Although the present embodiments have been described with reference to specific example embodiments, it will be evident that various modifications and changes may be made to these embodiments without departing from the broader spirit and scope of the various embodiments.

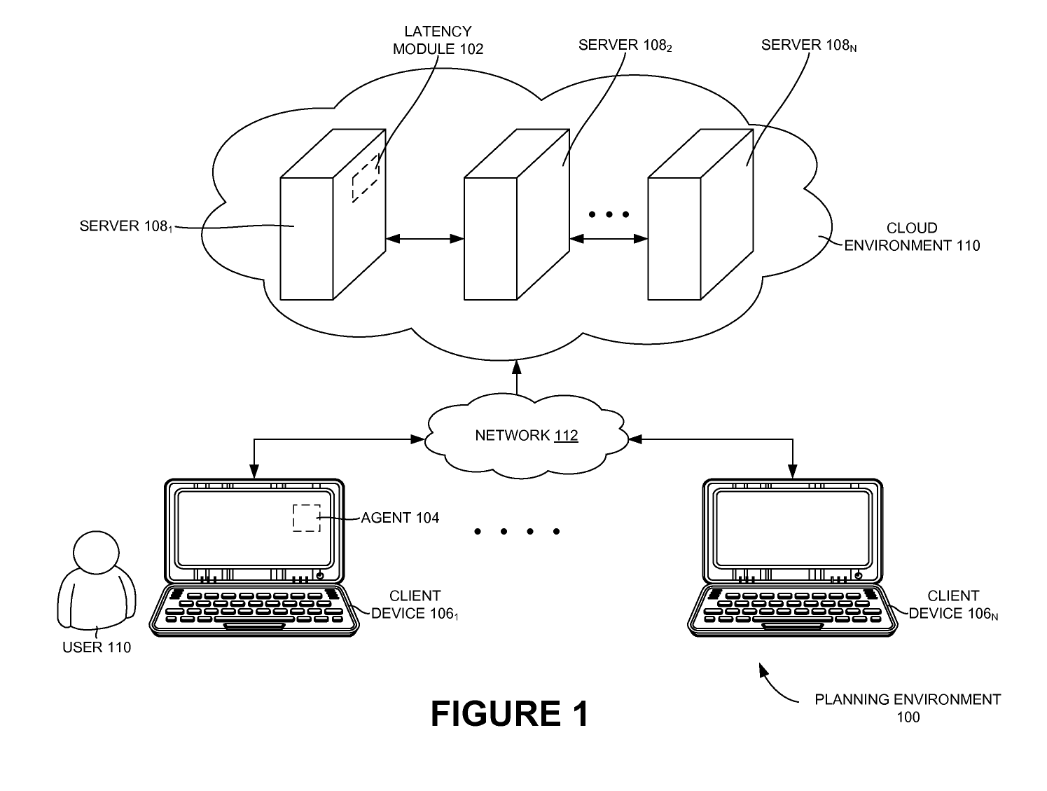

FIG. 1 is a schematic representation of a block diagram of an environment 100, according to one or more embodiments.

The planning environment 100 includes a latency module 102, an agent 104, one or more client device(s) 106_{1-N} (herein referred as a client device 106) and one or more server(s) 108_{1-N} (herein referred as server 108). Examples of the client device(s) 106_{1-N} may include, but are not limited to, computers, mobile phones, laptops, palmtops, and personal digital assistants (PDAs). The agent 104 can be internally or externally coupled to the client device 106.

The latency module 102 may be in electronic communication with the server 108 in a cloud environment 110. The server 108 may be an independent entity in the cloud environment 110 for analyzing and processing data. The server 108 and the latency module 102 may include one or more hardware elements.

In one embodiment, the planning environment 100 may include one or more server(s) 108_{1-N} in a distributed network of the cloud environment 110, in order to perform distributed computations. The server(s) 108_{1-N} may include one or more communication interfaces and one or more storage devices to store the server instructions. The server(s) 108_{1-N} also include one or more processors coupled to the storage devices that are responsive to the server instructions required for functioning of the servers.

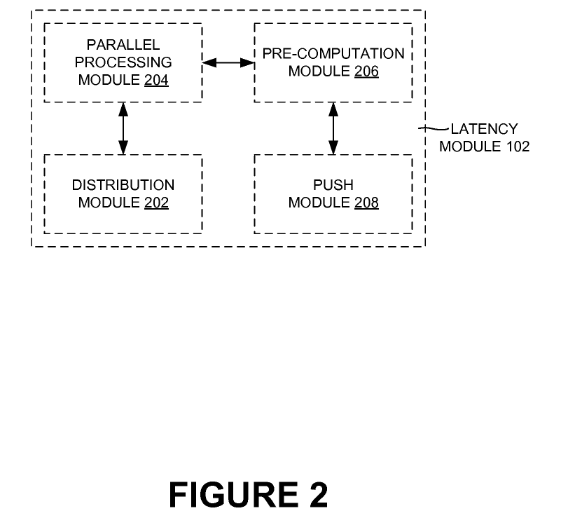

Various embodiments are related to use of the server 108 for implementing techniques described hereafter, for example technique described in FIG. 1 and FIG. 2. The techniques can be performed by the server 108 in response to execution of instructions in a server memory by a server processor. The instructions can be read into the server memory from another machine-readable medium, such as a storage unit.

The term machine-readable medium may be a medium providing data to a machine to enable the machine to perform a specific function. The machine-readable medium can include storage media. Storage media can include non-volatile media and volatile media. The server memory may be volatile media. All such medias may be tangible to enable the instructions carried by the media to be detected by a physical mechanism that reads the instructions into the machine.

Examples of the machine readable medium include, but are not limited to, a floppy disk, a flexible disk, hard disk, magnetic tape, a CD-ROM, optical disk, punchcards, papertape, a RAM, a PROM, EPROM, and a FLASH-EPROM.

In some embodiments, the server 108 may include a server communication interface coupled to the bus for enabling data communication. Examples of the server communication interface include, but are not limited to, an integrated services digital network (ISDN) card, a modem, a local area network (LAN) card, an infrared port, a Bluetooth port, a zigbee port, and a wireless port.

In some embodiments, the server processor may include one or more processing units for performing one or more functions of the server processor. The processing units are hardware circuitries that perform specified functions.

In some embodiments, the server 108 may be in electronic communication with the client device 106 through a network 112. Examples of the network 112 include, but are not limited to, a Local Area Network (LAN), a Wireless Local Area Network (WLAN), a Wide Area Network (WAN), wired network, wireless network, internet and a Small Area Network (SAN).

The sales and operations planning may be an integrated business management process through which the executive or leadership team continually achieves focus, alignment and synchronization among all functions of the organization. The sales and operations plan may include an updated sales plan, production plan, inventory plan, customer lead time (backlog) plan, new product development plan, strategic initiative plan and resulting financial plan.

In one example, the user may be a sales account executive of the enterprise. The report can include, but not limited to, data associated with the sales and operations plan for a particular time period and region. For example, the user may view a report of sales and operations plan, of a particular month associated with a product.

The user in assistance with the client device 106 may determine a set of data (hereinafter referred to as data) of the sales and operations plan. The user may make a request to the server 108 through the network 112 to analyze the data based on an interdependency of the data.

The server 108 may receive the request from the client device 106. The server 108 may perform parallel processing of the data through the distributed network in order to reduce a latency of generation of the report. The server 108 analyzes the data based on an optimization analysis, a conflict resolution analysis and/or historical trends associated with the sales and operations plan.

The server 108 may generate the report and delivers the report to the client device 106 through the network 112. The user may view the report and proceed for making another request accordingly, if needed.

In some embodiments, the server 108 may receive multiple requests at the same instant from multiple users of the client devices. For example the server 108₁ receives three requests from the client device 106₁, a client device 106₂ and a client device 106₃. The server 108₁ can then forward the request from the client device 106₂ to a server 108₂, and the request from the client device 106₃ to a server 108₃, and accept the request form the client device 106₁. The server 108₂ and the server 108₃ may be interconnected with the server 108₁ in the distributed network. The task of forwarding requests to multiple servers can be based on predefined criteria.

FIG. 2 is a schematic representation of the latency module 102 of the server 108 of the cloud environment 110, according to one or more embodiments. The latency module 102 may include a distribution module 202, a parallel processing module 204, a pre-computation module 206 and a push module 208. The distribution module 202 is in electronic communication with the parallel processing module 204. The parallel processing module 204 is in electronic communication with the pre-computation module 206. The pre-computation module 206 is in electronic communication with the push module 208.

The latency module 102 may reduce latency during generation of the report and/or build plan in response to the request made by the user of the client device 106 to the server 108. The latency module 102 may use the parallel processing module 204 in conjunction with the distribution module 202 to perform parallel processing of the data received from the client device 106. In one embodiment, the distribution module 202 may process the set of data of a sales and operations plan 350 and separate the set of data of a sales and operations plan 350 based on a conflict analysis, such that the separate components of the set of data of a sales and operations plan 350 may be processed in parallel. In one embodiment, the parallel processing module 204 processes a separate component (e.g. subset) of the set of data of a sales and operations plan 350. In another embodiment the parallel processing module 204 may coordinate the parallel processing of the data through the distribution network.

The pre-computation module 206 may create a “what if” build plan proactively prior to a request of a supply chain analyst in the cloud infrastructure based on a historical record to minimize a delay when the request is submitted. The server 108 may process a change between the current calculation and the previous calculation of the sales and operations plan. The pre-computation process may reduce latency in generating the report.

The latency module 102 may enable the delivery of the report generated by the server 108 through the push module 208. In one embodiment, the push module may provide an update to the client device 106 of a proactively created “what if” build plan. The update may be a change between a current calculation and a previous calculation of the sales and operations plan and/or “what if” build plan.

In one embodiment, the distribution module 202, the parallel processing module 204, the pre-computation module 206 and the push module 208 can be considered as the hardware elements of the latency module 102.

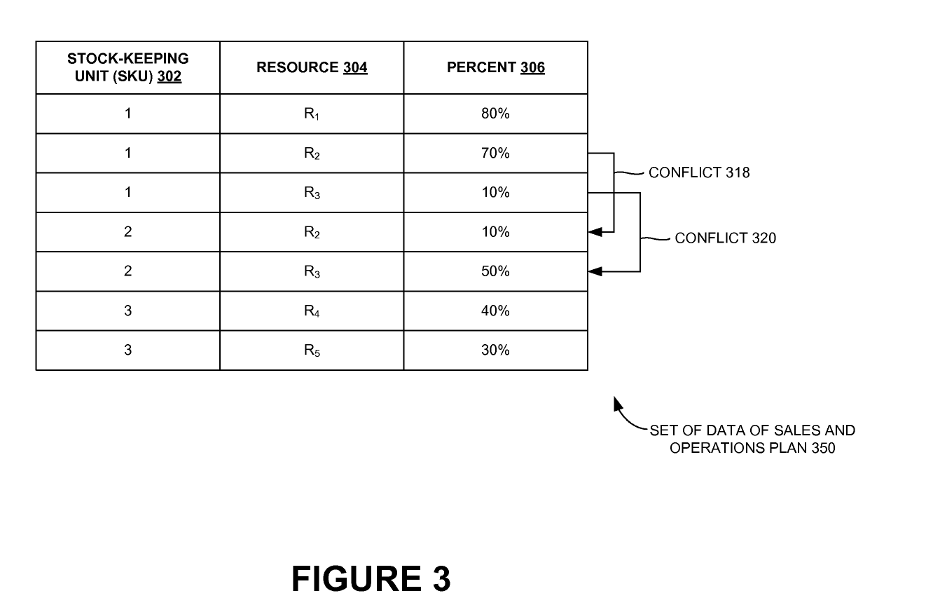

FIG. 3 is a schematic representation of a table 350 of a set of data of sales and operations plan in accordance with one embodiment. The table 300 may include a first column representing a list of stock-keeping units 302, a second column representing a list of resources 304. The table 350 may also include a third column representing consumption rates (in percentage 306) of resources 304 by the stock-keeping units 302. The stock-keeping units 302, the resources 304 and the consumption rates in percentage 306 can be referred to as contents of the table 350.

In some embodiments, the resource is one of a commodity and a human resource used in a production of goods and services. The table 350 provides a matrix of the stock-keeping units 302 and the resources 304.

In a first region, a first stock-keeping unit 1 utilizes a first resource_{R1}. The consumption rate of the first resource_{R1} by the first stock-keeping unit 1 is 80%. Similarly, the first stock-keeping unit 1 utilizes a second resource_{R2}. The consumption rate of the second resource_{R2} by the first stock-keeping unit 1 is 70%. The first stock-keeping unit 1 utilizes a third resource_{R3}. The consumption rate of the third resource_{R3} by the first stock-keeping unit 1 is 10%.

In a second region, a second stock-keeping unit 2 utilizes the second resource R₂. The consumption rate of the second resource R₂ by the second stock-keeping unit 2 is 10%. Similarly, the second stock-keeping unit 2 utilizes the third resource R₃. The consumption rate of the third resource R₃ by the second stock-keeping unit 2 is 50%.

The server 108 may receive the request to generate the report based on the analysis of the contents of the table 350. The server 108 determines a first conflict 318 between the first stock-keeping unit 1 and the second stock-keeping unit 2 due to common utilization of the second resource R₂. Similarly, the server 108 determines a second conflict 320 between the first stock-keeping unit 1 and the second stock-keeping unit 2 due to common utilization of the third resource R₃.

The server 108 may resolve the first conflict 318 and the second conflict 320 based on the conflict resolution analysis. The conflict resolution analysis may be the analysis that uses an iterative process based on a weighting of the data and a priority of the data. The weighting may be assigned based on historical trends associated with the first stock-keeping unit 1 and the second stock-keeping unit 2.

In some embodiments, the server 108 resolves the first conflict 318 and the second conflict 320 based a conflict resolution that uses an iterative process based on a weighting of the supply plan and the demand plan.

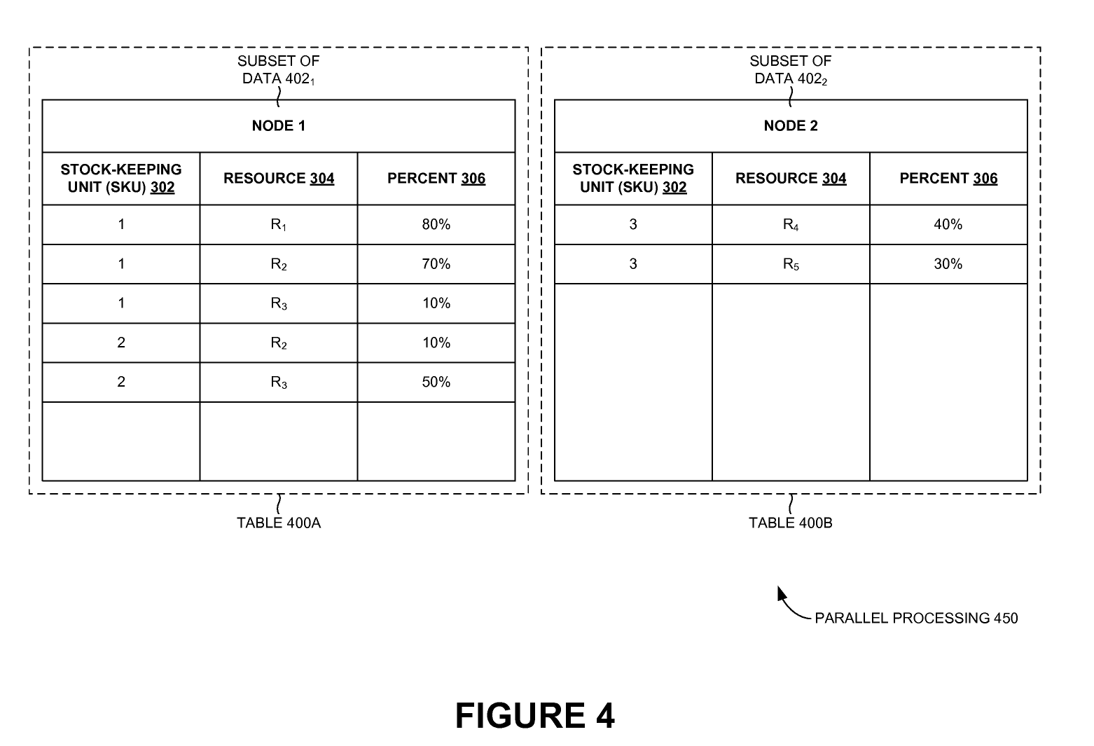

FIG. 4 is a schematic representation of a first table (hereinafter referred to as a table 400A) and a second table (hereinafter referred to as a table 400B) of contents of parallel processing of sales and operations plan in accordance with one embodiment. The set of data of a sales and operations plan 350 may be separated into two tables, for example table 400A and table 400B, based on a conflict analysis. The two tables, table 400A and table 400B, may be processed in parallel through node 1 and node 2, respectively, to reduce a latency in the processing of the set of data of a sales and operations plan 350.

The table 400A includes a subset of data 402₁. The subset of data 402₁ may be processed through node 1. The node 1 includes a first column of a list of a first stock-keeping unit 1 and a second stock-keeping unit 2. The node 1 also includes a second column of a list of a first resource R₁, a second resource R₂ and a third resource R₃. The node 1 includes a third column of a list of consumption rates in percentage 306 of the first resource R₁ and the second resource R₃ by the first stock-keeping unit 1 and the second stock-keeping unit 2.

The table 400B includes a subset of the data 402₂. The subset of data 402₂ may be processed through node 2. The node 2 includes a first column of a list of a third stock-keeping unit 3. The node 2 also includes a second column of a list of a fourth resource R₄, and a fifth resource R₅. The node 2 includes a third column of a list of consumption rates in percentage 306 of the fourth resource R₄ and the fifth resource R₅ by the third stock-keeping unit 3.

The node 1 and the node 2 can be referred as interconnected processing units in the distributed network for processing incoming requests received by the one or more client devices. The server 108 may receive data contained in the table 400A and the table 400B. In order to reduce latency during generation of a first report and a second report respective to data contained in table 400A and table 400B, the server 108 may perform parallel processing. The parallel processing through a distributed network may reduce a latency in generating a report and/or build plan.

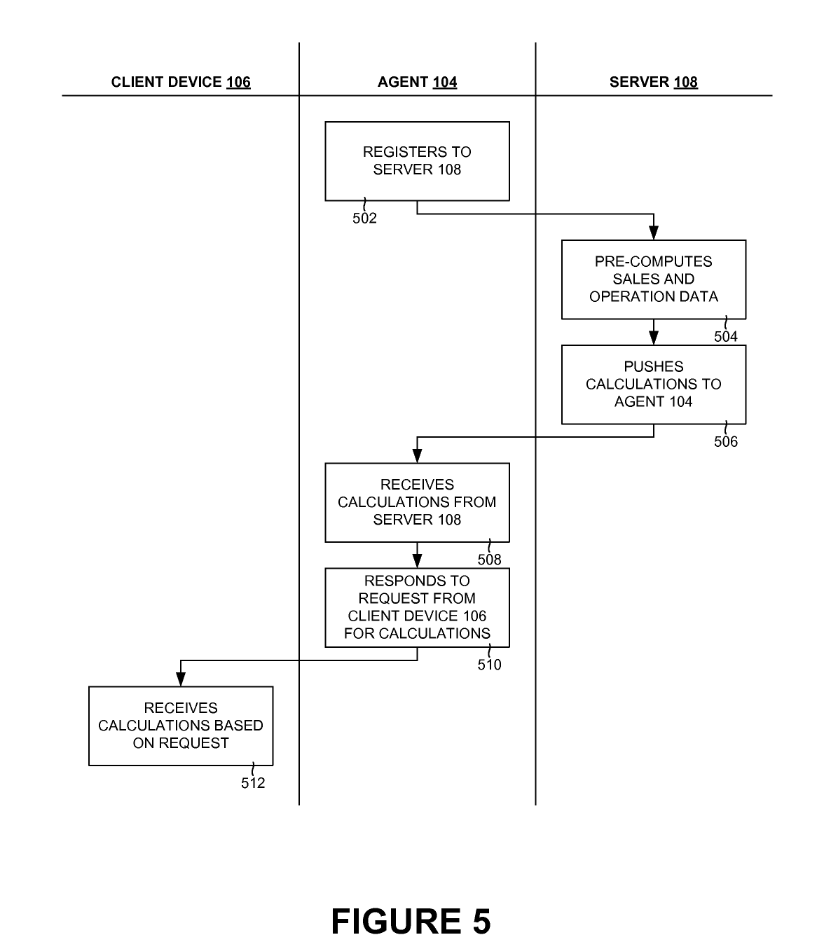

FIG. 5 is a schematic representation of a flowchart for generating a response based on analyzing an input data in accordance with one embodiment. In an example embodiment, the flowchart represents a process flow incorporating a pre-computation to reduce latency through the creation of a “what if” build plan proactively.

The user of the client device 106 may electronically view the report of the sales and operations plan associated with the enterprise located at a particular region. The user may be the sales account executive of the enterprise. The report can include, but not limited to, data associated with the sales and operations plan for a particular time period and region.

At step 502, the client device 106 may be registered by the server 108 through the agent 104. For example, the user may send a registration request to the server 108. The server 108 can perform a check to determine if the user registration request is already received and stored in the database coupled to the server 108. The server 108 may accept the registration request. The server 108 may store the user details and the client device 106 details in the database. The user details can be, but not limited to, employee ID and location, enterprise address.

The server 108 may communicate a notification message to the user that signifies an acceptance of the registration request and may permit the client device 106 to initiate further requests. In some embodiments, the server 108 may authorize the client device 106 to send requests. A client device 106 may be authorized by the server 108 when the agent 104 is identified by the server 108.

At step 504, the data of sales and operations may be pre-computed through the server 108. Pre-computation may include the creation of a “what if” build plan proactively prior to a request of a supply chain analyst in the cloud infrastructure based on a historical record to minimize a delay when the request is submitted. The server 108 may process a change between the current calculation and the previous calculation of the sales and operations plan. The pre-computation process may reduce latency in generating the report.

At step 506, the server 108 forwards the calculated data associated with the report to the agent 104. At step 508, the agent 104 receives the calculations from the server 108. At step 510, the agent 104 responds to the request sent by the client device 106 for calculations associated with the report. At step 512, the client device 106 receives the calculations associated with the report from the agent 104.

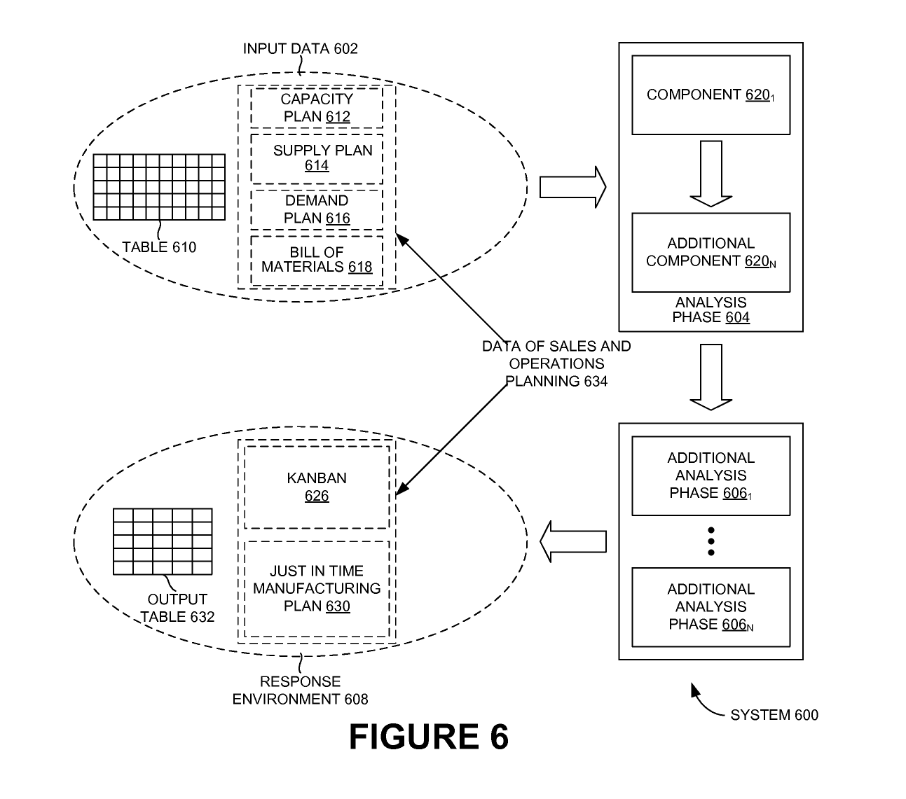

FIG. 6 is a schematic representation of a system 600 generating a response based on analyzing an input in accordance with one embodiment. The system 600 includes the input data 602, an analysis phase 604, an additional analysis phase 606 and a response environment 608.

The input data 602 may be in a form of a table 610. The input data 602 may include a capacity plan 612, a supply plan 614, a demand plan 616 and a bill of materials 618. In one or more embodiments, the input data 602 may obtain other data of sales and operations planning 634.

The analysis phase unit 604 includes one or more components 620_{1-N}. There may be one or more additional analysis phase unit 606_{1-N}. The response environment 608 can include, but not limited to, Kanban 626, Just-in-time manufacturing plan 630. The report of the Kanban 626 and/or the Just-in-time manufacturing plan 630 may be in the form of a table.

The input data 602, the analysis phase unit 604, the one or more additional analysis phase unit(s) 606_{1-N} and the response environment 608 may be in electronic communication with the server 108 and the client device 106 through the network 112. In some embodiments, the input data 602 may be internally and electronically coupled to the agent may 104 of the client device 106.

The bill of materials may be a list of the raw materials, sub-assemblies, intermediate assemblies, sub-components, components, parts and the quantities of each to manufacture an end product by the enterprise.

The server 108 through the analysis phase 604 and the one or more additional analysis phase unit(s) 606_{1-N} may generate the report. The analysis phase unit 604 and the one or more additional analysis phase unit(s) 606_{1-N} may contribute in analyzing the conflict resolution, the historical trend analysis and the optimization analysis. The optimization analysis may be an analysis to achieve the objective of the report. In one embodiment, the objective of the sales and operations plan is to reduce cost.

The server 108 may communicate the report as a response to the response environment 608. The report (in the form of table 632) may be include the Kanban 626 and the Just-in-time manufacturing plan 630. The Kanban 626 may be a scheduling system that tells an enterprise what to produce, when to produce it, and how much to produce based on the report received by the server 108. The Just-in-time manufacturing plan 630 may use an inventory strategy that strives to improve a business's return on investment by reducing in-process inventory and associated carrying costs based on the report received by the server 108.

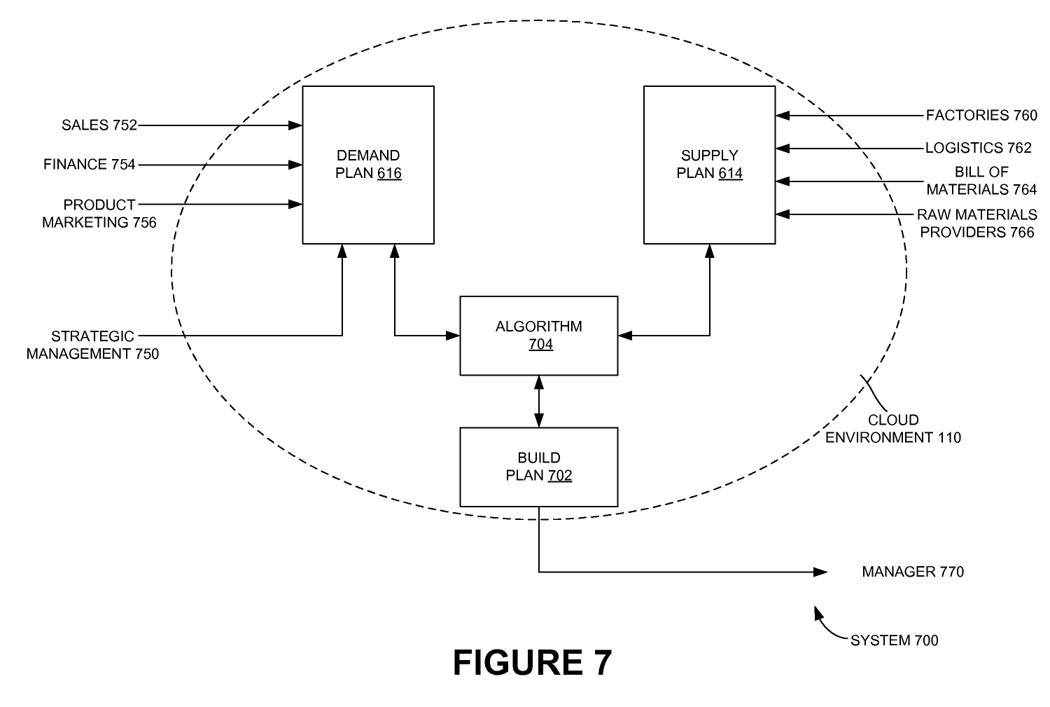

FIG. 7 is a schematic representation of a system 700 for creating a build plan in accordance with one embodiment. The system 700 may include a build plan 702, an algorithm 704, the supply plan 614 and the demand plan 616. The build plan 702, the algorithm 704, the supply plan 614 and the demand plan 616 may be present in the cloud environment 110.

The supply plan 614 may be based on one or more predefined factors. Examples of the predefined factors may include, but are not limited to, raw material providers 766, logistics 762, bill of materials 764 and raw material providers 766. For example, the supply plan 614 may be created in a distributed cloud infrastructure (also referred to as the cloud environment 110) based on another supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder. A particular aspect may be a segmented view of the supply plan depending on a role and/or responsibility of a stakeholder to the enterprise.

The demand plan 616 may be based on one or more predefined factors. Examples of the predefined factors may include, but are not limited to, sales 752, finance 754, product marketing 756 and strategic management 750. For example, the demand plan 616 may be created in the distributed cloud infrastructure based on a demand-forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. A certain aspect may be a segmented view of the demand plan depending on a role and/or responsibility of a stakeholder to the enterprise.

The client side visualizations may be through a plug-in of an off the shelf spreadsheet application. An example of an off the shelf spreadsheet application is Microsoft® Excel. The demand-side stakeholder and the supply-side stakeholder may be internal to an organization creating the build plan. In alternate embodiments, the demand-side stakeholder and the supply-side stakeholder may be external to an organization creating the build plan.

The server 108 may determine a set of processing units in the distributed cloud infrastructure to process the demand plan and the supply plan. The server 108 may apply a planning algorithm using a combined processing power of available ones of the set of processing units in the distributed cloud infrastructure to create a build plan and/or report. The demand plan and/or the supply plan may be processed in the distributed cloud infrastructure.

When the set of processing units in the distributed cloud infrastructure is unavailable, the request to create the build plan may be reverted to a dedicated server. The advanced planning system algorithm may consider a capacity constraint, a manufacturing constraint, a lead time constraint, and a cost constraint when creating the build plan. The server 108 may create a “what if” build plan proactively prior to the request of a supply chain analyst in the cloud infrastructure based on a historical record to minimize a delay when the request is submitted.

The server 108 may create the build plan based on the historical trend analysis, the conflict resolution analysis and the optimization analysis. The server 108 may create the build plan continuously such that a current calculation of the build plan is available to the client device 106. The server 108 may determine the change between the current calculation and a previous calculation of the build plan to reduce the latency of an access of the current calculation through a delivery of the change to the client device 106 through a push mode module 208.

The servers in the cloud environment 110 may handle multiple requests to generate various types of reports. The servers may be capable of parallel processing of such requests in order to reduce latency to serve the multiple requests.

The build plan 702 may be reviewed by a manager 770. The manager may include but is not limited to a Chief Executive Officer (CEO), project manager, sales manager and the like. In one or more embodiments, after the review of the build plans, the manager may modify the build plans to improve operations or based on and certain other constraints.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer device), and may be performed in any order (e.g., including using means for achieving the various operations). Accordingly, the specification and drawings are to be regarded in an illustrative rather than a restrictive sense.

What is claimed is:

1. A method comprising:
creating a demand plan in a distributed cloud infrastructure based on a demand-forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder;
creating a supply plan in the distributed cloud infrastructure based on another supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder;
determining that a set of processing units in the distributed cloud infrastructure is available to process the demand plan and the supply plan;
applying a planning algorithm using a combined processing power of available ones of the set of processing units in the distributed cloud infrastructure to create a build plan when the at least one of the demand plan and the supply plan is processed in the distributed cloud infrastructure; and
reverting to a dedicated server processing to create the build plan when the set of processing units in the distributed cloud infrastructure is unavailable.

2. The method of claim 1 wherein:
at least one of the demand-side stakeholder and the supply-side stakeholder is external to an organization creating the build plan.

3. The method of claim 2 wherein:
the advanced planning system algorithm considers a capacity constraint, a manufacturing constraint, a lead time constraint, and a cost constraint when creating the build plan.

4. The method of claim 3 wherein:
the client side visualizations are through a plug-in in an off the shelf spreadsheet application.

5. The method of claim 4 wherein:
the off the shelf spreadsheet application is one of Microsoft® Excel and a proprietary web-based spreadsheet application.

6. The method of claim 5 further comprising:
creating a “what if” build plan proactively prior to a request of a supply chain analyst in the cloud infrastructure based on a historical record to minimize a delay when the request is submitted.

7. The method of claim 6 further comprising:
creating the build plan based on a historical trend analysis, wherein the historical trend analysis is an analysis that uses a previous calculation as a basis for a current calculation.

8. The method of claim 7 further comprising:
creating the build plan based on a conflict resolution analysis, wherein the conflict resolution analysis is an analysis that uses an iterative process based on a weighting of the supply plan and the demand plan.

9. The method of claim 8 further comprising:
creating the build plan based on an optimization analysis, wherein the optimization analysis is an analysis to achieve the objective of the build plan, wherein the resource is one of a commodity and a human resource used in a production of goods and services, and wherein the objective of the sales and operations plan is to reduce a cost.

10. The method of claim 9 further comprising:
creating the build plan continuously such that a current calculation of the build plan is available to the client device.

11. The method of claim 10 further comprising:
determining a change between the current calculation and a previous calculation of the build plan; and
reducing the latency of an access of the current calculation through a delivery of the change to the client device through a push model.

12. The method of claim 1 in the form of a machine-readable medium embodying a set of instructions that, when executed by a machine, cause the machine to perform the method of claim 1.

13. A method of a client device comprising:
determining a set of a data of a sales and operations plan such that a report of the sales and operations plan is generated based on an analysis of the data;
processing the set of the data of the sales and operations plan such that the data is processed through a distributed network of a cloud environment;
reducing a latency of a generation of the report of the sales and operations plan through a parallel processing of the set of the data of the sales and operations plan through the distributed network of the cloud environment; and
processing a part of the sales and operations plan based on the set of the data of the sales and operations plan prior to a request through a client device such that the latency is reduced when a calculation of the part of the sales and operations plan is requested through the client device.

14. The method of claim 13 further comprising:
determining the sales and operations plan based on a historical trend analysis, wherein the historical trend analysis is the analysis that uses a previous calculation as a basis for a current calculation.

15. The method of claim 14 further comprising:
determining the sales and operations plan based on a conflict resolution analysis, wherein the conflict resolution analysis is the analysis that uses an iterative process based on a weighting of the data and a priority of the data.

16. The method of claim 15 further comprising:
determining the sales and operations plan based on an optimization analysis, wherein the optimization analysis to achieve the objective of the sales and operations plan, wherein the resource is one of a commodity and a human resource used in a production of goods and services, and wherein the objective of the sales and operations plan is to reduce a cost.

17. The method of claim 16 further comprising:
processing a change between the current calculation and the previous calculation of the sales and operations plan; and
reducing the latency of an access of the current calculation through a delivery of the change to the client device through a push model.

18. A system comprising:
a client device to determine a set of a data of a sales and operations plan such that a report of the sales and operations plan is generated based on an analysis of the data;
a server device to analyze the set of the data of the sales and operations plan based on an interdependency of the data; and
an agent to register the client device to the server device such that the server device pushes a calculation of the sales and operations plan to the client device.

19. The system of claim 18 wherein:
the server device to reduce a latency of a generation of the report of the sales and operations plan through a parallel processing of the set of the data of the sales and operations plan through a distributed network of a cloud environment.

20. The system of claim 19 wherein:
the server device to process a part of the sales and operations plan based on the set of the data of the sales and operations plan prior to a request through the client device such that the latency is reduced when the calculation of the part of the sales and operations plan is requested through the client device.
